(19) United States
(12) Patent Application Publication
(10) Pub. No.: US 2026/0201855 A1
(43) Pub. Date: Jul. 16, 2026

(54) FUEL INJECTOR

(71) Applicant: PHINIA DELPHI LUXEMBOURG SARL, Belvaux (LU)

(72) Inventor: Michael Peter Cooke, Rochester (GB)

(21) Appl. No.: 19/133,939

(22) PCT Filed: Dec. 7, 2023
(86) PCT No.: PCT/EP2023/084698

§ 371 Date: May 29, 2025

(30) Foreign Application Priority Data
Dec. 7, 2022 (GB) 2218410.5

(51) Int. Cl. F02M 21/02

(52) U.S. Cl. CPC F02M 21/0263; F02M 21/0254

(57) ABSTRACT

A fuel injector for delivering gaseous fuel to an internal combustion engine includes a nozzle body having a nozzle bore. A valve needle is disposed for axial movement within the nozzle bore and includes a valve head engageable with a valve seat to control gaseous fuel delivery through at least one outlet of the fuel injector. The fuel injector includes a first guide including a radially inner contact surface disposed for contacting the valve needle to radially align the valve head with the valve seat. The valve needle includes a first thinned portion that is flexible, so as to allow bending of the valve needle responsive to contact between the first guide and the valve needle

### FIELD OF THE INVENTION

This invention relates to a fuel injector for use in a gaseous fuel injection system. In particular, the invention relates to a fuel injector for gaseous fuel such as hydrogen for delivering fuel to an internal combustion engine.

### BACKGROUND

In fuel injection systems for liquid fuel, it is known for a fuel pump to supply fuel to a high-pressure accumulator (or common rail), from where it is delivered into each cylinder of the engine by means of a dedicated fuel injector. Typically, a fuel injector has an injection nozzle that is received within a bore provided in a cylinder head of the cylinder, and a valve needle which is actuated to control the release of high-pressure fuel into the cylinder from spray holes provided in the injection nozzle. One simple way of opening and closing a valve needle is to couple a solenoid actuator directly to the valve needle, by attaching an armature of the actuator to the valve needle (or by providing a valve needle with an integral armature). The valve needle is biased towards a seating surface so that, when the solenoid is not energised, the valve needle prevents fuel flow through the spray holes. When the solenoid is actuated, the valve needle is lifted away from its valve seat and fuel injection takes place.

Fuel injectors and injection systems may be configured in a similar manner for use with gaseous fuel, such as hydrogen. In this case, the hydrogen is typically held at high pressure in a storage tank of the vehicle, for example up to 700 bar. Particularly when delivering fuels under higher pressures, the forces involved in opening and closing the valve needle of a fuel injector can impart significant kinetic energy to the fuel injector's components that must be dissipated, as well as generating lateral forces that can de-centre or misalign the components. The lack of lubricity of gaseous fuel such as hydrogen adds an additional challenge because of wear at the valve seat, which in a liquid fuel injector is counteracted by the lubricating quality of the fuel.

It is against this background that the invention has been devised.

### SUMMARY OF THE INVENTION

According to a first aspect, there is provided a fuel injector for delivering gaseous fuel to an internal combustion engine, the fuel injector comprising:
a nozzle body having a nozzle bore; and
a valve needle disposed for axial movement within the nozzle bore and including a valve head engageable with a valve seat to control gaseous fuel delivery through at least one outlet of the fuel injector;
wherein the valve needle comprises a first thinned portion, the first thinned portion being flexible so as to allow bending of the valve needle responsive to compression of the valve head against the valve seat.

The flexibility of the first thinned portion may reduce wear between the first guide and valve needle, and reduce lateral sliding of valve head relative to the valve seat at impact.

The fuel injector may comprise a first guide comprising a radially inner contact surface disposed for contacting the valve needle to at least partly radially align the valve head with the valve seat.

The valve head may be disposed axially between the first thinned portion and the valve seat.

The valve needle may comprise a first widened portion at an end of the valve needle nearer the valve seat to define the valve head, the valve head defining a valve needle seating surface for seating against the valve seat. The radially inner contact surface of the first guide may be configured to contact a radially outer surface of the valve head to radially align the valve needle seating surface with the valve seat. This may improve alignment between the valve head and the valve seat, which may reduce vibration and wear.

The valve needle seating surface may be of convex form and may be formed to complement the shape of the valve seat, to ensure a good seal when contact is made between the valve needle seating surface and the valve seat.

The radially outer surface of the valve head may be parallel, in an axial direction, to the radially inner contact surface of the first guide. This may assist in maintaining concentric alignment between the valve head and the valve seat while the valve needle is moving axially in use.

The bending of the valve needle in response to the contact between the first guide and the valve needle may cause the valve head to pivot laterally. Such lateral pivoting may mean that less sideways movement of the valve needle is needed to accommodate misalignment of the valve head, which may in turn mean less lateral vibration and reduced lateral sliding of the valve head at impact with the valve seat.

The first thinned portion may taper in an axial direction from the valve head, then flare in the axial direction along at least part of the rest of the length of the first thinned portion. This may reduce stress concentrations and/or assist in dissipation of energy, particularly where the transitions are curved in longitudinal section.

The thinnest part of the first thinned portion may be located axially closer to the valve head than an axial mid-point of the first thinned portion. This may place the most flexible region of the first thinned portion closer to the valve head, allowing for a greater lateral pivoting action of the valve head relative to the rest of the valve needle. In addition, less sideways movement of the valve needle may be needed to accommodate pivoting relative to the seat as the valve head engages it. This in turn may mean less lateral vibration and reduced lateral sliding.

The valve needle may comprise a second thinned portion that is axially separated from the first thinned portion by a second widened portion. The second widened portion may be axially positioned so as to reduce buckling of the valve needle.

The second thinned portion may taper in an axial direction from the second widened portion, then flare in the axial direction along at least part of the rest of the length of the second thinned portion. This may reduce stress concentrations and/or assist in dissipation of energy, particularly where the transitions are curved in longitudinal section.

The thinnest part of the second thinned portion may be located axially further from the second widened portion than an axial mid-point of the second thinned portion. This may place the most flexible region of the second thinned portion further from the second widened portion, which increases pivoting of the valve needle closer to the second guide member. This means that less of the mass of the valve needle has to move sideways to accommodate bending, so lateral vibrations may be reduced.

The first and second thinned portions may be of relatively different axial lengths and/or have different longitudinal profiles. This may result in different resonance characteristics for the thinned portions, which can reduce ringing in the valve needle after impact with the seat and/or reduce bounce of the valve head when it engages the valve seat.

The fuel injector may comprise a second guide comprising a radially inner contact surface disposed for contacting the valve needle to radially align the valve needle with the nozzle bore. The second guide member may guide and radially locate the valve needle during operation of the fuel injector, while also reacting to dynamic sideloads generated in use.

The valve needle may comprise a third thinned portion that is disposed on a side of the second guide that is axially distal to the valve head, the third thinned portion being flexible so as to allow bending of the valve needle responsive to lateral forces imposed upon it during use. The third thinned portion may reduce transmission of sideloads by allowing a relatively short section of the valve needle to bend near the third thinned portion to accommodate lateral forces.

According to a second aspect, there is provided a fuel injector for delivering gaseous fuel to an internal combustion engine, the fuel injector comprising:
a nozzle body having a nozzle bore;
a valve needle disposed for axial movement within the nozzle bore and including a valve head engageable with a valve seat to control gaseous fuel delivery through at least one outlet of the fuel injector;
a first guide comprising a radially inner contact surface disposed for contacting the valve needle to radially align the valve head with the valve seat; and
a second guide axially spaced apart from the first guide, the second guide comprising a radially inner contact surface disposed for contacting the valve needle to radially align the valve needle with the nozzle bore;
wherein the valve needle comprises a thinned portion that is disposed on a side of the second guide that is axially distal to the valve head, the thinned portion being flexible to allow bending of the valve needle responsive to forces imposed upon it during use.

A thinned portion having the described flexibility may reduce transmission of sideloads and/or improve energy dissipation in use.

The fuel injector may comprise a spring for pushing the valve needle in the direction of the valve seat, wherein the thinned portion and the spring at least partly axially overlap.

The fuel injector may comprise an actuator that, when actuated, urges the valve needle away from the valve seat and compresses the spring, such that tension within the thinned portion is increased.

It will be appreciated that preferred and/or optional features of the first aspect of the invention may be incorporated alone or in appropriate combination in the second aspect of the invention also, and vice versa.

### BRIEF DESCRIPTION OF THE DRAWINGS

In order that the invention may be more readily understood, preferred non-limiting embodiments thereof will now be described, by way of example only, with reference to the accompanying drawings, in which:

FIG. 1 is a cross-sectional view of a fuel injector of a first embodiment of the invention;

FIGS. 2 to 4 are enlarged cross-sectional views showing the nozzle tip of the fuel injector of FIG. 1, in different states of operation;

FIGS. 5 and 6 are schematic cross-sectional views of a further fuel injector illustrating lateral sliding of a valve needle in operation;

FIG. 7 is an enlarged cross-sectional view of an upper guide of the fuel injector of FIGS. 1 to 4; and

FIG. 8 shows two graphs of seat pressures and lateral seat sliding during operation of different fuel injectors.

In the drawings, as well as in the following description, like features are assigned like reference signs.

### SPECIFIC DESCRIPTION

Throughout this description, terms such as ‘upper’ and ‘lower’, and other directional references, are used with reference to the orientation of the fuel injector as shown in the accompanying drawings. However, it will be appreciated that such references are not limiting and that fuel injectors according to the invention can be used in any orientation.

### DETAILED DESCRIPTION OF THE INVENTION

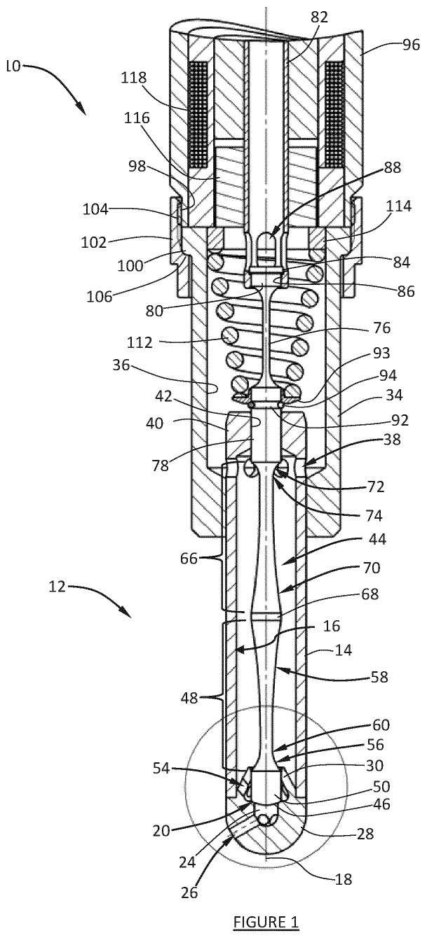

FIG. 1 shows a first embodiment of a fuel injector 10 or injector assembly for injecting gaseous fuel in an internal combustion engine. The fuel injector 10 is of the inwardly-opening type comprising an injection nozzle 12 having a substantially cylindrical nozzle body 14 that defines a nozzle bore 16. The nozzle bore 16 in turn defines a central bore axis 18.

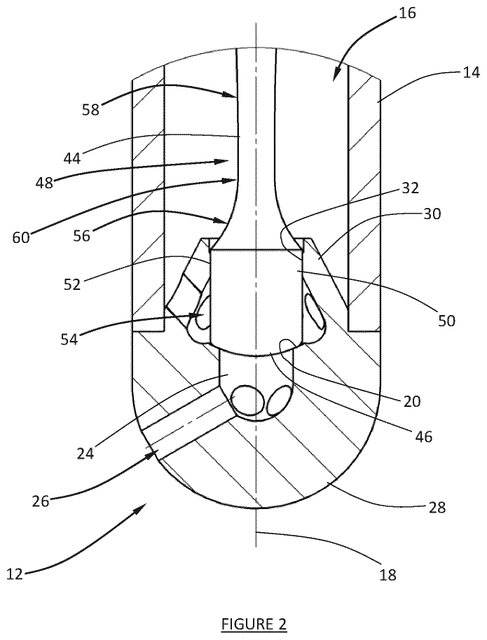

A valve seat 20 is disposed at a lower end (relative to the orientation of FIG. 1) of the nozzle bore 16, and comprises a generally annular contact area. As best shown in FIG. 2, the contact area of the valve seat 20 is a generally annular portion of a spherical surface. A sac volume 24 is defined within a nozzle tip 28 located at the lower end of the fuel injector 10, the volume 24 extending downwards from the opening defined by the valve seat 20. Several nozzle outlets 26 extend through the nozzle tip 28. In the cross section of FIG. 1 only three outlets are visible, but in practice the nozzle tip 28 may be provided with any number of outlets so as to ensure a high cross sectional flow area is available for fuel exiting the injector 10.

The nozzle tip 28 includes a projection or extension which extends into the nozzle bore 16 and defines a first guide member 30 for guiding movement of a valve needle of the injector, referred to generally as 44. The first guide member 30 defines a generally hollow frusto-conical shape in longitudinal section, with the shape of the cone extending in a radially inward and axially upward direction from a lower end of the nozzle bore 16. A frusto-conical guide surface (the radially inner contact surface 32 of the first guide member 30) defined by the first guide member 30 therefore narrows in a direction away from the nozzle tip 28. The radially inner contact surface 32 includes several circumferentially spaced apertures 54 for passage of gaseous fuel when the fuel injector 10 is in use. The apertured first guide 30 therefore provides a guiding function while allowing fuel to flow past the guide 30 into the sac volume 24.

An upper portion of the nozzle body 14 is received within an internal bore 36 defined within a tubular housing 34. The upper portion of the nozzle body 14 includes a second guide member 40 at its upper end and includes several radially spaced cross drillings or apertures 38 in this region of the second guide member 40 to provide a fluid path between the internal bore 36 in the tubular housing 24 and the nozzle bore 16 in the nozzle body 14. The second guide member 40 is provided with an axially extending bore which extends between the upper and lower faces of the second guide member 40 to defines a guide surface 42 (a radially inner contact surface 42 of the second guide member 40) for a portion of the valve needle 44.

The valve needle 44 extends along the bore axis 18 through the nozzle bore 16, the internal bore 36, and the second guide member 40. The valve needle 44 includes a valve needle seating surface 46 defined by a first widened region, or valve head 50, at an end of the valve needle 44 proximal to the valve seat 20. The valve needle seating surface 46 is convex at its lower end. The valve needle seating surface 46 may be shaped to be complementary to the contact area of the valve seat 20. The complementary relationship between the valve needle seating surface 46 and the valve seat 20 provides a seal when the valve needle 44 is in the closed position.

In other implementations, the portion of the valve seating surface 46 that engages with the valve seat 20 can take any suitable shape in longitudinal section, such as conical, frusto-conical, or planar, for example. However, the use of a rounded, and optionally a spherical, profile on the valve needle seating surface 46 and the valve seat 20 enables a smooth rolling motion between the surfaces as the valve head 50 pivots, as described in more detail below with respect to FIG. 4.

Referring also to FIG. 2, the valve head 50 includes a radially outer surface 52 that is parallel, in an axial direction, to the radially inner contact surface 32 of the first guide member 30. The fuel injector assembly 10 is configured such that the radially inner contact surface 32 of the first guide member 30 contacts the radially outer surface 52 of the valve head 50, so as to radially align the valve needle seating surface 46 with the valve seat as described in more detail below.

The valve needle 44 comprises an elongate valve stem, carrying the valve head 50 at its lower end. The elongate stem includes a first thinned portion 48 and a second thinned portion 66. In the implementation of FIGS. 1 and 2, the first thinned portion 48 is disposed immediately above the valve head 50. The first thinned portion 48 includes, at its lower end, a lower flared or outwardly-tapered portion 56 that tapers or flares outwardly, in an axial direction from a thinnest portion 60 of the first thinned region 48, towards the valve head 50. Towards its upper end, the first thinned portion 48 also includes a flared portion 58 that tapers or flares outwardly, in the axial direction, from the thinnest portion 60, along at least part of the rest of the length of the first thinned portion 48. The outer surface profile of the longitudinal section of the first thinned portion 48, through tapered and flared regions 56 and 58, is continuously curved, which reduces stress concentrations and assists in dissipation of energy in use, as described in more detail below.

The thinnest point 60 of the first thinned portion 48 is located axially closer to the valve head 50 than an axial mid-point of the first thinned portion 48. The result of this geometry is to place the most flexible region of the first thinned portion 48 closer to the enlarged valve head 50, which allows for a greater lateral pivoting action of the valve head 50 relative to the rest of the valve needle 44, as compared with if the most flexible region were further from the valve head 50. This means less sideways movement of the valve needle 44 as a whole is needed to accommodate lateral forces in use. This in turn means less lateral vibration and less tendency for lateral sliding of the valve head 50 against the valve seat 20 at impact.

The first thinned portion 48 is sufficiently flexible that it allows bending of the valve needle 44 responsive to contact between the valve head 50 and the valve seat 20. In particular, when the valve needle seating surface 46 of the valve head 50 initially contacts the valve seat 20 at a position laterally offset from bore axis 18, further compression of the valve head 50 against the valve seat 20 causes pivoting of the valve head 50 about the point of initial contact, as described in more detail below with reference to FIG. 4.

Optionally, the contact surface 32 can overlap, axially, with a centre of a sphere based upon which the part-spherical shape of the valve seat 20 is formed.

The convex or rounded nature of the valve needle seating surface 46, and the cooperably shaped valve seat 20, enables a smooth rolling motion between the valve needle 44 and the valve seat 20 as the valve needle pivots or bends, so the combination of the valve needle seating surface 46 being convex or rounded, and the first thinned portion 48, are particularly effective together.

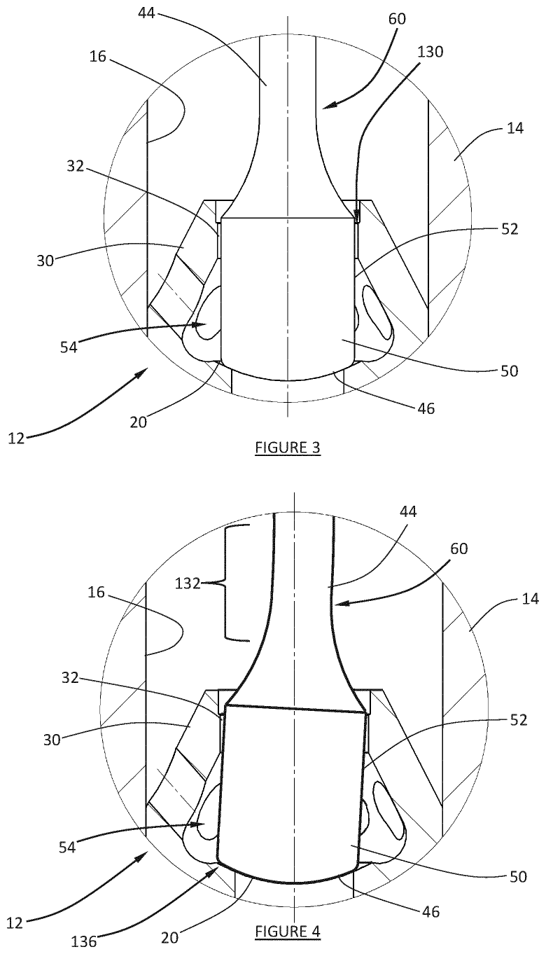

An example of wear that can be reduced as a result of the bending offered by the thinned portion 48 is shown in FIGS. 5 and 6. For clarity, FIGS. 5 and 6 omit many of the details of the implementation of FIGS. 1 to 4, but features in common between the Figures are indicated by like reference signs.

In FIG. 5, the valve needle 44 is descending within the nozzle bore 16, such that the valve head 50 is approaching the valve seat 20. The valve needle 44 does not include a thinned portion such as thinned portion 48, but instead is generally cylindrical along its length.

The path of the valve needle 44 is guided by the inner surface of the nozzle bore 16. However, some clearance is required around the valve needle 44, leading to a small amount of space 62 being present between the valve needle 44 and the surface of the nozzle bore 16. Due to alignment issues that can be exacerbated by off-centre forces generated by the return spring and actuator (not shown), the valve head 50 (the lower end of the valve needle) can be slightly off-centre as it approaches the valve seat 20. This is shown by the increased space 62 on the right-hand side of FIG. 5 as compared with that on the left-hand side.

As shown in FIG. 6, as the valve head 50 engages with the valve seat 20, the off-centre contact with the valve seat 20 causes the valve needle seating surface 46 to slide towards the centre of the valve seat 20, as indicated by arrow 64. The effect can be similar where the valve seat 20 and the end of valve head 50 take other shapes, such as part-spherical.

For fuel injectors for conventional fuels used in combustion engines (e.g. diesel), the use of hard metals and hard coatings allows such sliding to take place without major wear on the valve seat.

In contrast, the injection of gaseous fuels, and particularly hydrogen, presents potential issues. The lubricity of gaseous fuels such as hydrogen is low, which can increase wear. For low pressure hydrogen injection of the order of tens of bar, a polymer or elastomer seating surface could be provided, to deform and accommodate a degree of misalignment without sliding and also provide some damping. However, to improve engine efficiency, it is desirable to inject hydrogen late in the compression stroke to avoid having to do additional compression work on the fuel. To inject hydrogen sufficiently quickly against the high cylinder pressure at such a time requires hundreds of bar. Polymer or elastomer seats are unable to work at such high pressures, as the contact pressures would exceed the compressive strength of the material.

As a result, the use of gaseous fuels such as hydrogen, particularly at relatively high pressures, can result in increased seat and valve needle wear.

FIG. 3 shows a close-up of the first guide member 30, showing a gap 130 between its radially inner contact surface 32 and the outer surface 52 of the first widened portion 50 (the gap 130 is exaggerated for clarity). In FIG. 3, the valve head 50 is aligned with the bore axis 18, and hence is centred relative to the valve seat 20. In this case, there are no significant lateral forces generated as the valve head 50 engages the valve seat 20.

FIG. 4 also shows a close-up of the first guide member 30. However, in this case (and as is often the case in practice), the valve head 50 initially engages the valve seat 20 at a position that is laterally offset from the bore axis 18. In the scenario illustrated in FIG. 4, the valve needle 44 has descended towards the valve seat 20, the valve head 50 sliding down the radially inner contact surface 32 of the first guide member 30, to the left of the valve head 50. The valve needle seating surface 46 first engaged the valve seat 20 on the left hand side, at the laterally offset point indicated by arrow 136.

The axial force imposed by the nozzle spring 112, and momentum of the valve needle 44, generate a torque in the valve head around the laterally offset point 136. Due to the increased flexibility of the first thinned portion 48 (especially in the region of the thinnest portion 60), this torque causes the valve head 50 to pivot clockwise, causing the valve needle seating surface 46 to rotate down into full contact with the valve seat 20 as shown in FIG. 4.

By allowing this pivoting to take place, there is no need for the valve head 50 to slide laterally into alignment with bore axis 18 to engage the valve seat 20. Instead, the first thinned portion 48 allows the valve head 50 to pivot into place, which significantly reduces wear.

In the implementation of FIG. 4, the centre of the radius of curvature of the valve needle seating surface 46 is positioned approximately at the axial midpoint of the first guide member 30 when the valve head 50 is engaged with the valve seat 20. The pivoting takes places around this centre of the radius of curvature. This in turn allows for a reduced gap 130 between the radially outer surface 52 of the valve head 50 and the radially inner contact surface 32 of the first guide member 30. The reduced gap allows the first guide member 30 to better align the initial contact of the valve head 50 with the valve seat 20.

An additional advantage of the valve needle 44 bending around the thinnest portion 60 is that it dissipates energy and reduces valve bounce.

The skilled person will appreciate that a rounded, and optionally a spherical, profile on the valve needle seating surface 46 and the valve seat 20 enables a smooth rolling motion between the surfaces as the valve head 50 pivots. However, other profiles may be used in different implementations.

Returning to FIGS. 1 to 4, the valve needle 44 comprises a second thinned portion 66 that is axially separated from the first thinned portion 48 by a second widened portion 68. The second thinned portion 66 comprises a tapered portion 70 that tapers in an axial direction from the second widened portion 68. The second thinned portion 66 also comprises a flared portion 72 that flares in the axial direction along the rest of the length of the second thinned portion. The outer surface profile of the longitudinal section through tapered and flared portions 70 and 72 of the second thinned portion 66 is continuously curved, which reduces stress concentrations and assists in dissipation of energy in use, as described in more detail below.

The upper end of the second thinned portion 66 terminates at a third widened portion 78. Third widened portion 78 is cylindrically formed and is sized to be a sliding fit within the second guide member 40. The second guide member 40 helps to guide and radially locate the valve needle 44 during operation of the fuel injector 10, while also reacting to dynamic sideloads generated in use.

Above the second guide member 40, the third widened portion 78 includes a circumferential groove 92, within which is disposed a circlip 94 to retain a spring seat member 93 for a valve needle spring 112.

A thinnest portion 74 of the second thinned portion 66 is located axially further from the second widened portion 68 than an axial mid-point of the second thinned portion 66. The result of this geometry is to place the most flexible region of the second thinned portion further from the second widened portion 68, which increases pivoting of the valve needle 44 closer to the second guide member 40, as compared with if the most flexible region were closer to the second widened portion 68. This means that less of the mass of the valve needle 44 has to move sideways to accommodate lateral forces, so less energy is imparted to the valve needle 44 and lateral vibrations may be reduced.

The provision of the second widened portion 68 between the first and second thinned portions helps stiffen the valve needle 44 in the central region where it would be most prone to buckling under compression. The second widened portion 68 therefore forms an anti-buckle feature.

In addition, the curved outer profiles (in longitudinal section) of the flared/tapered regions minimize stress concentrations while also improving the dynamic behaviour of the valve needle. Stress waves reflecting off the curved surfaces are spread in different directions, dispersing them by making them incoherent and effectively damping the waves without needing high damping properties in the material itself.

The first thinned portion 48 and the second thinned portion 66 can be of different diameters and/or lengths. The lengths, diameters, and general profiles of the tapered and flared portions can be selected such that the first thinned portion 48 and the second thinned portion 66 have different resonance characteristics, which can reduce ringing in the valve needle after impact with the seat and/or reduce bounce of the valve head 46 when it engages the valve seat 20, as described in more detail below.

By way of non-limiting example, in one implementation, the second widened portion 68 can have a diameter of around 3 to 5 mm, such as 4 mm for example, while the thinnest portions 60 and 74 of the respective first and second thinned portions 48 and 66 can have a diameter of around 1 to 1.6 mm, such as 1.2 mm for example. Dimensions and ratios will be selected by the skilled person to suit the valve needle dynamics, loads, clearances, etc, of the particular implementation.

The section of the fuel injector 10 around an upper end of the valve needle 44 will now be described in more detail.

Above the second guide member 40, the valve needle comprises a third thinned portion 76. The third thinned portion 76 is flexible so as to allow bending of the valve needle responsive to lateral forces imposed upon it during use, as described in more detail below, as well as to accommodate any axial misalignment that may exist.

The lower end of the third thinned portion 76 tapers away from the third widened portion 78. The upper end of the third thinned portion 76 flares to a fourth widened portion 80.

The fourth widened portion 80 is fitted within a pull tube 82 that extends along the axis of the fuel injector 10. The axially upper end of the fourth widened portion 80 includes an external flange 84. The external flange 84 interacts with an internal flange 86 formed inside the lower end of the pull tube 82. Axial engagement between the external flange 84 and the internal flange 86 prevents the pull tube 82 and the flange 84 from separating under tension.

The pull tube 82 is hollow, and includes circumferentially spaced radial apertures 88 immediately above the internal flange 86.

A solenoid housing 96 is coupled to an upper end of the tubular housing 34 by a connecting sleeve 102. The solenoid housing 96 includes a threaded portion 98 on an outer surface of its lower end. An upper end of the tubular housing 34 includes an outer flange 100. The connecting sleeve 102 includes a threaded portion 104 on an inner surface of its upper end, and a circumferential ledge 106 near its lower end. The connecting sleeve 102 is screwed onto the solenoid housing 96 by way of the threaded portions 98 and 104. The tubular housing 34 is axially clamped to the solenoid housing 96 due to the interaction between the outer flange 100 and the circumferential ledge 106 as the connecting sleeve 102 is screwed into place. The internal bore 36 houses the nozzle spring 112. The nozzle spring 112 is concentric with the third thinned portion 76 and is compressed between the spring seat member 93 and a spacer ring 114 that abuts a lower axial face of the solenoid housing 96.

An armature 116 is attached to an outer surface of the pull tube 82, such that forces acting on the armature 116 are coupled to the pull tube 82 and vice versa. A coil 118 is disposed within the solenoid housing 96 adjacent to the armature 116.

The nozzle spring 112 is under compression in FIG. 1, holding the valve needle 44 in the closed position such that the valve head 50 is engaged with the valve seat 20. When the valve needle 44 is in this position, no gaseous fuel is able to escape from the sac volume 24 through the nozzle outlets 26.

When fuel is to be delivered by the fuel injector 10, the coil 118 is energised, causing the armature 116 to move upwardly. This causes the pull tube 82 and the valve needle 44 to move upwardly as well, against the force of the nozzle spring 112. The upward movement of the valve needle 44 disengages the valve head 50 from the valve seat 20. This allows high-pressure hydrogen gas (or whichever gaseous fuel is in use) to pass through the interior of the pull tube 82, then through the apertures 88 in the pull tube 82, the internal bore 36, the apertures 38 in the tubular housing 34, the nozzle bore 16, the apertures 54 in the first guide member 30, into the sac volume 24 and then out of the fuel injector 10 through the nozzle outlets 26.

The fuel injector 10 is closed by de-energising the coil 118, which allows the nozzle spring 68 to push the valve needle 44 downwards until the valve head 50 engages the valve seat 20.

To ensure prompt closing of the fuel injector 10 upon de-energising of the coil 118, the nozzle spring 112 generates a significant return force. As such, the nozzle spring 112 imparts considerable kinetic energy to the valve needle 44 as it moves towards the closed position, all of which must be dissipated. Some of the energy is dissipated by shockwaves passing up through the valve needle 44 after it strikes the valve seat 20. In addition, depending upon the configuration of the components of the fuel injector 10, the valve needle 44 can bounce one or more times after it initially strikes the valve seat 20, which is undesirable both for reasons of both fuel flow control and increased wear.

These issues can be exacerbated when a gaseous fuel, and particularly a relatively lightweight gaseous fuel such as hydrogen, is used. Heavier combustible fuels such as diesel tend to generate a squeeze film between surfaces as they approach each other. These and other fluid damping effects can reduce needle bouncing and wear.

The use of one or more thinned portions having the described flexibility can offer the additional advantage of improved energy dissipation. The energy can be dissipated in various ways, such as through axial and/or lateral oscillations of regions of the needle valve 44. The thinned portions can offer increased lateral oscillations, for example, and smoothly contoured (in axial profile) flared and tapered regions, when used, can offer better dissipation of energy waves within the valve needle 44.

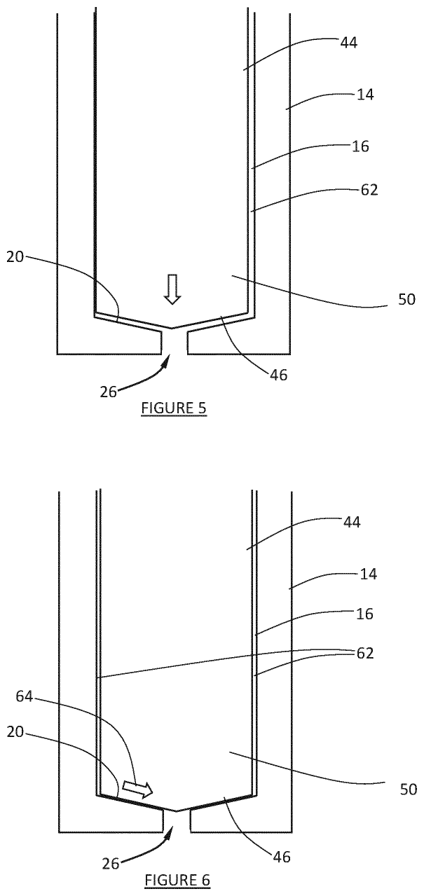

FIG. 7 shows an enlarged cross-sectional view of the fuel injector 10 of FIGS. 1 to 4. Valve needle 44 is shown centralized within the second guide member 40, which is the ideal (lateral/concentric) position for it to be in during the cycle of the fuel injector opening and closing. However, when the fuel injector is actuated, the forces imposed on the valve needle 44 by the nozzle spring 112 and the armature 116 are unlikely to be perfectly balanced. This results in dynamic and inconsistent sideloads being placed on the valve needle 44 throughout the actuation cycle.

The thinnest portion 74 of second thinned portion 66 reduces the transmission of such sideloads by allowing a relatively short section of the valve needle 44 to bend around the second thinned portion 66 to accommodate lateral forces. This bending is shown as valve needle 134 in dashed lines in FIG. 7. In implementations without the second thinned portion 66, a greater portion, and hence mass, of the valve needle 44 would need to move laterally in response to lateral forces, requiring greater energy. This would potentially increase wear and add vibrational energy that would need to be dissipated.

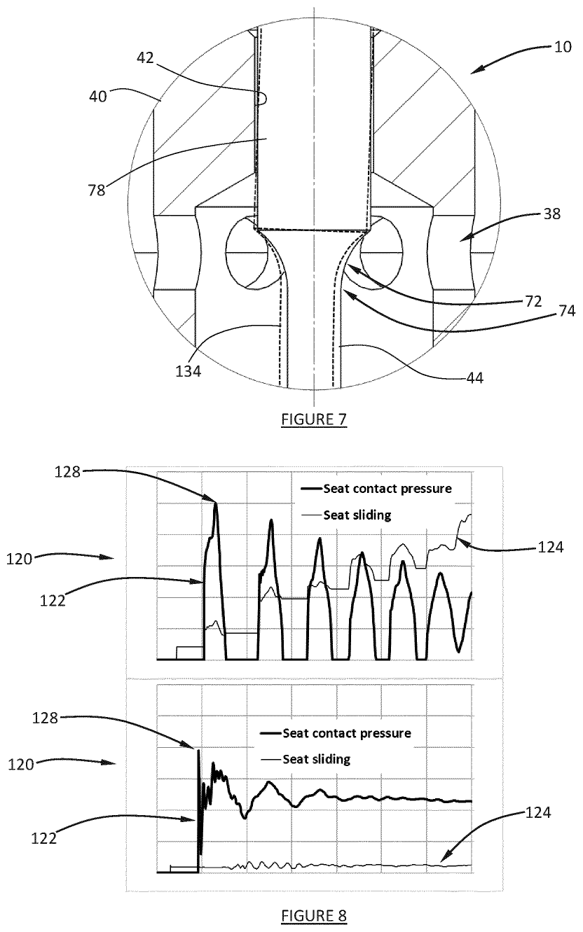

FIG. 8 shows two graphs showing the results of dynamic finite element analysis of a fuel injector. The first graph 120 shows an analysis of a constant diameter valve needle hitting a seat, showing seat contact pressure 122. Peak contact pressure 128 is when the valve needle first hits the seat. The seat contact pressure 122 drops to zero five times after initial contact, showing that the valve needle bounces five times before remaining closed. The first graph 120 also shows the amount of lateral seat sliding 124 that takes place on each of these bounces.

The second graph 126 shows the performance of a fuel injector under identical conditions, except that the valve needle has a flexible thinned portion 48, 66 as described herein. The peak contact pressure 128 is lower in the second graph 126 than the first graph 120. In addition, there is no bounce, showing that the force waves are quickly dissipated, and there is minimal lateral seat sliding 124. The reduced bounce and lateral seat sliding significantly reduces wear around the valve seat.

The fuel injector can be designed to work with compressed hydrogen fuel, optionally provided at a pressure of at least 50 bar. The advantages of the invention may increase with hydrogen supply pressures above about 100 bar, and particularly above about 150 bar.

The word “thinned” takes its ordinary meaning to the skilled person, which may include, for example, being thinned relative to a widest portion of the valve needle, or to one or more axially adjacent portions of the valve needle. “Thinned” can mean having a smaller cross sectional area, and/or a smaller maximum or minimum diameter (irrespective of whether the thinned section is circular in cross-section) relative to a widest portion of the valve needle, or to one or more axially adjacent portions of the valve needle. The first and second thinned portions 48 and 66, for example, are “thinned” in the sense of being thinner than the widened portions disposed at their axial ends.

### List of Parts

10—fuel injector
12—nozzle
14—nozzle body
16—nozzle bore
18—bore axis
20—valve seat
24—sac volume
26—nozzle outlets
28—nozzle tip
30—first guide member
32—radially inner contact surface
34—tubular housing
36—internal bore
38—apertures
40—second guide member
42—radially inner contact surface
44—valve needle
46—valve needle seating surface
48—first thinned portion
50—valve head
52—radially outer surface of valve head
54—apertures in first guide
56—tapered portion
58—flared portion
60—thinnest portion of first thinned portion
62—space around needle valve
64—lateral arrow
66—second thinned portion
68—second widened portion
70—tapered portion
72—flared portion
74—thinnest point
76—third thinned
78—third widened portion
80—fourth widened portion
82—pull tube
84—external flange
86—internal flange of pull tube
88—radial apertures in pull tube
92—groove in third widened portion
93—spring seat member
94—circlip
96—solenoid housing
98—threaded portion
100—outer flange
102—connecting sleeve
104—threaded portion
106—circumferential ledge
112—nozzle spring
114—spacer ring
116—armature
118—coil
120—first graph
122—seat contact pressure
124—lateral seat sliding
126—second graph
128—peak contact pressure
130—gap
132—region around thinnest portion 60
134—dashed valve needle
136—initial contact point with valve seat

1. A fuel injector for delivering gaseous fuel to an internal combustion engine, the fuel injector comprising:
a nozzle body having a nozzle bore;
a valve needle disposed for axial movement within the nozzle bore and including a valve head engageable with a valve seat to control gaseous fuel delivery through at least one outlet of the fuel injector; and
wherein the valve needle comprises a first thinned portion, the first thinned portion being flexible so as to allow lateral bending of the valve needle responsive to compression of the valve head against the valve seat.

2. The fuel injector claim 1, comprising a first guide comprising a radially inner contact surface disposed for contacting the valve needle to at least partly radially align the valve head with the valve seat.

3. The fuel injector of claim 1, wherein the valve head is disposed axially between the first thinned portion and the valve seat.

4. The fuel injector of claim 3, wherein the valve needle comprises a first widened portion at an end of the valve needle nearer the valve seat to define the valve head, the valve head defining a valve needle seating surface for seating against the valve seat, wherein the radially inner contact surface of the first guide is configured to contact a radially outer surface of the valve head to radially align the valve needle seating surface with the valve seat.

5. The fuel injector of claim 4, wherein the radially outer surface of the valve head is parallel, in an axial direction, to the radially inner contact surface of the first guide.

6. The fuel injector of claim 4, wherein the bending of the valve needle in response to the contact between the first guide and the valve needle causes the valve head to pivot laterally.

7. The fuel injector of claim 4, wherein the valve head (50) includes a convex surface to define the valve needle seating surface (46).

8. The fuel injector of claim 4, wherein the first thinned portion tapers in an axial direction from the valve head, then flares in the axial direction along at least part of the rest of the length of the first thinned portion.

9. The fuel injector of claim 8, wherein a thinnest part of the first thinned portion is located axially closer to the valve head than an axial mid-point of the first thinned portion.

10. The fuel injector of claim 3, wherein the valve needle comprises a second thinned portion that is axially separated from the first thinned portion (48) by a second widened portion (68).

11. The fuel injector of claim 10, wherein the second thinned portion tapers in an axial direction from the second widened portion, then flares in the axial direction along at least part of the rest of the length of the second thinned portion.

12. The fuel injector of claim 10, wherein a thinnest part of the second thinned portion is located axially further from the second widened portion than an axial mid-point of the second thinned portion.

13. The fuel injector of claim 10, wherein the first and second thinned portions are of relatively different axial lengths and/or have different longitudinal profiles.

14. The fuel injector of claim 1, comprising a second guide comprising a radially inner contact surface disposed for contacting the valve needle to radially align the valve needle with the nozzle bore.

15. The fuel injector of claim 14, wherein the valve needle comprises a third thinned portion that is disposed on a side of the second guide that is axially distal to the valve head, the third thinned portion being flexible so as to allow bending of the valve needle responsive to lateral forces imposed upon it during use.

16. A fuel injector for delivering gaseous fuel to an internal combustion engine, the fuel injector comprising:
a nozzle body having a nozzle bore;
a valve needle disposed for axial movement within the nozzle bore and including a valve head engageable with a valve seat to control gaseous fuel delivery through at least one outlet of the fuel injector;
a first guide comprising a radially inner contact surface disposed for contacting the valve needle to radially align the valve head with the valve seat; and
a second guide axially spaced apart from the first guide, the second guide comprising a radially inner contact surface disposed for contacting the valve needle to radially align the valve needle with the nozzle bore;
wherein the valve needle comprises a thinned portion that is disposed on a side of the second guide that is axially distal to the valve head, the thinned portion being flexible to allow bending of the valve needle responsive to forces imposed upon it during use.

17. The fuel injector of claim 16, comprising a spring for pushing the valve needle in the direction of the valve seat, wherein the thinned portion and the spring at least partly axially overlap.

18. The fuel injector of claim 17, comprising an actuator that, when actuated, urges the valve needle away from the valve seat and compresses the spring, such that tension within the thinned portion is increased.
